(19) United States
(12) Patent Application Publication
(10) Pub. No.: US 2024/0274901 A1
(43) Pub. Date: Aug. 15, 2024

(54) Registration Method for Digital Radiography of Thin Flexible Multilayer Materials

(71) Applicant: United States Of America as Represented By The Administrator Of NASA, Washington, DC (US)

(72) Inventors: Joshua L. Brown, Newport News, VA (US); Peter W. Spaeth, Yorktown, VA (US); William C. Schneck, III, Fort Monroe, VA (US); Matthew J. Godbold, Cayce, SC (US); Daniel F. Perey, Yorktown, VA (US)

(21) Appl. No.: 18/436,734

(22) Filed: Feb. 8, 2024

Related U.S. Application Data
(60) Provisional application No. 63/444,349, filed on Feb. 9, 2023.

(51) Int. Cl. H01M 10/48; G06T 3/40; G06T 7/00; G06T 7/33; H01M 10/0525; H01M 50/105

(52) U.S. Cl. CPC H01M 10/48; G06T 3/40; G06T 7/001; G06T 7/33; H01M 10/0525; H01M 50/105; G06T 2207/10116; G06T 2207/20221; G06T 2207/30108; G06T 2207/30204

(57) ABSTRACT

A registration method for digital radiography of thin flexible multilayer materials, which includes adding surface modifications to a product formed from thin flexible multilayer materials to create high contrast registration markers. The present approach is suited for products that would otherwise display few distinguishable features in high-resolution narrow field of view images. The registration markers are used to register and align a series of high-resolution narrow field of view images of separate portions of a thin, flexible, multilayer product. The aligned images may be digitally stitched together to form a high-resolution composite image of the whole product. The resulting composite image may allow nondestructive inspection to analyze changes to the internal structure of the product over time. The flexible multilayer materials with registration markers may be used in battery cell pouches, which permits tracking internal changes of a lithium-ion pouch cell battery over time.

### CROSS-REFERENCES TO RELATED APPLICATIONS

This application claims the benefit of U.S. Provisional Patent Application No. 63/444,349, filed Feb. 9, 2023, and incorporates the disclosure of the application by reference.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE TECHNOLOGY

Global lithium-ion battery capacity is expected to rise upwards of 5,500 gigawatt-hour (GWh) between 2021 and 2030. The quality assurance of lithium-ion battery cells is an important requirement in enabling markets for these batteries to develop and mature. Identification and location of defects inside battery cells before the performance decreases or safety issues arise is a challenge. For example, it is known that new battery cells might contain small defects that are not detectable using current methods of testing and inspection. Thin pliable materials, such as lithium-ion pouch-cells of aluminum laminate film, are often difficult image; such flexible films may include polyamide, foil, polypropylene, and adhesives. If left uncaught, these defects have the potential to result in severe safety, reliability, and performance problems during their operational life. Because of this, battery manufacturers can face high rates of battery rejection due to undetected cell defects. In addition, the inability to effectively monitor the development of defects over time impacts the ability to schedule maintenance actions to remove selected cells before failure.

### BRIEF SUMMARY OF THE TECHNOLOGY

Low contrast digital radiography (DR) images may result from attempting to image conventional, spatially uniform, low-attenuation material (e.g., foils or laminates that are similar to the thin pliable materials that make up lithium-ion battery pouch cells) with respect to the imaging technical circumstances.

The present approach is a registration method for digital radiography of thin flexible multilayer materials according to various aspects of the present technology includes adding surface modifications to a product or pouch formed from thin flexible multilayer materials to create a set of high contrast registration markers for a product that would otherwise display few if any distinguishable features in individual high-resolution narrow field of view images that would allow for registration of the images. The set of registration markers are used to register and align a series of high-resolution narrow field of view images comprising separate portions or subsections of a product or battery cell pouch made from the thin flexible multilayer materials. The aligned images may be digitally stitched together to form a high-resolution composite image of the whole product. The resulting composite image provides a nondestructive method of inspection to analyze changes to the internal structure of the product over its operational period.

One embodiment of the disclosed technology describes a method for digital radiography of thin flexible multilayer materials, which includes a non-functional modification to those materials to provide visibility into the progression of defects in the materials over time. Another embodiment includes a flexible pouch modified with registration markers as disclosed herein, used to register and align a series of high-resolution narrow field of view images. With thin pliable materials, such as lithium-ion pouch-cells, it is often difficult to register DR images because the materials rarely include a sufficient number of inherent features in DR images to allow for image registration. This property impairs the ability to obtain high-resolution images to perform a useful visual inspection of the inner structure of the pouch-cell. The disclosed technology provides the ability to produce a high-resolution composite DR image of a pouch-cell. Although one representative embodiment for the technology is directed to cells of lithium-ion batteries, other embodiments of this technology may be used with other articles having similar thin, pliable materials that produce low contrast images with few distinguishing features from other imaging methods.

The set of registration markers may be tailored to a sample as may be desired, which may be described as a DR fingerprint. This modification enables the formation of high-resolution composite images from a series of individual high-resolution images that each include at least one set of registration markers. In addition to initial quality assurance, the images may be used periodically to detect changes over the life of a given product such as a battery. For context, a high-resolution image generally means achieving one or more orders of magnitude higher in spatial resolution in contrast to a lower resolution full-field conventional image. With X-ray hardware (e.g., a “micro-CT”), the conventional resolution for a single DR would be about 0.005 mm per pixel covering a region of approximately 100 mm². Microscopes may provide higher resolutions with smaller fields of view. But with the present approach in the context of generating high-resolution images of a thin pliable material of a battery cell pouch, DR high-resolution images may be stitched together to achieve that resolution for the entire pouch cell (e.g., assuming a nominal length of 20 cm by 15 cm in width). For comparison, a conventional single full-field DR captured of the entire pouch cell would have a resolution of about 0.1 mm per pixel. This is because the X-ray detector contains an array of 2000 by 2000 receptors/pixels/chicklets. For ultrasound or thermal imaging, the resolution would be even lower.

One embodiment of the technology uses small photopolymer droplets to mount small sections of magnet wire on the material surface of a pouch-cell battery using a 3D printed jig. The cured polymer is invisible to DR, but the magnet wire creates a set of features that enables registration of a series of high-resolution images of subsections of the entire pouch-cell battery.

Another embodiment of the technology is to provide a method for modifying existing products to include registration markers to allow for high signal return imaging according to a desired modality of imaging.

Another embodiment of the technology is to provide a method for monitoring the progress of internal defects of a pouch-cell battery over time and to detect subtle precursors to failure.

Another embodiment of the present approach extends to a flexible pouch for a battery cell, where the flexible pouch is further adapted for use with an imaging device that may be used to obtain a series of high-resolution images. Such a flexible pouch may include a pouch body configured to be positioned around electrode layers of the battery cell. The pouch body may also include a plurality of grouped registration markers, where each grouping of registration markers is positioned along an outer facing surface of the pouch body. Each grouping of registration markers may be arranged to form a distinct or unique pattern relative to the remaining groupings of the plurality of grouped registration markers. The registration markers may be selected to provide a high signal return according to a type of imaging device used to obtain the series of high-resolution images.

In some embodiments, the flexible pouch's plurality of grouped registration markers may be arranged in a grid pattern along the outer facing surface of the pouch body. In some cases, the registration markers may be embedded within the pouch body. Alternatively, the registration markers may be affixed to the outer surface of the pouch body with a polymer. In some embodiments, the registration markers may be selected to provide a high signal return according to a type of imaging device used, in order to obtain a series of high-resolution images of the battery cell; the polymer may be selected to be invisible to the imaging device.

These and other features, advantages, and objects of the present technology will be further understood and appreciated by those skilled in the art by reference to the following specification, claims, and appended drawings.

### BRIEF DESCRIPTION OF THE SEVERAL VIEWS OF THE DRAWINGS

FIG. 1 representatively illustrates a pouch-cell battery in accordance with an exemplary embodiment of the present technology;

FIG. 2 representatively illustrates a low resolution digital radiograph of a pouch-cell battery in accordance with an exemplary embodiment of the present technology;

FIG. 3 representatively illustrates a jig for positioning registration markers on a surface of a pouch-cell battery in accordance with an exemplary embodiment of the present technology;

FIG. 4 representatively illustrates a single grouping of registration markers in accordance with an exemplary embodiment of the present technology;

FIG. 5 representatively illustrates a series of high-resolution digital radiographs of a pouch-cell battery having registration markers in accordance with an exemplary embodiment of the present technology;

FIG. 6A representatively illustrates a pouch-cell battery with registration markers in accordance with an exemplary embodiment of the present technology;

FIG. 6B representatively illustrates a composite high-resolution digital radiograph of the pouch-cell battery in accordance with an exemplary embodiment of the present technology; and

FIGS. 7A-7C representatively illustrate the progress of internal degradations over time in accordance with an exemplary embodiment of the present technology.

### DETAILED DESCRIPTION OF EXEMPLARY EMBODIMENTS

For purposes of description herein, the terms “upper,” “lower,” “right,” “left,” “rear,” “front,” “vertical,” “horizontal,” and derivatives thereof shall relate to the technology as oriented in the corresponding figures. However, it is to be understood that the technology may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present technology may be described in terms of functional block components and various processing steps. Such functional blocks may be realized by any number of components configured to perform the specified functions and achieve the various results. For example, the present technology may employ various optical imaging devices, filters, materials, and geometries, which may carry out a variety of operations. In addition, the technology described is merely one exemplary application for the disclosed method and modifications. Further, the present technology may employ any number of conventional techniques or methods of imaging, manufacture, coupling, or manipulating any type of image data received from an imaging device or field of view.

Methods and apparatus for a registration method for digital imaging of thin flexible multilayer materials according to various aspects of the present technology may operate in conjunction with any type of light or temperature-based imaging system such as digital radiography, x-ray, thermal imaging, ultrasonic, and the like imaging device used to obtain the series or set of high-resolution images. Various representative implementations of the present technology may be applied to any type of image capture device or infrared thermal imaging system for performing internal inspections.

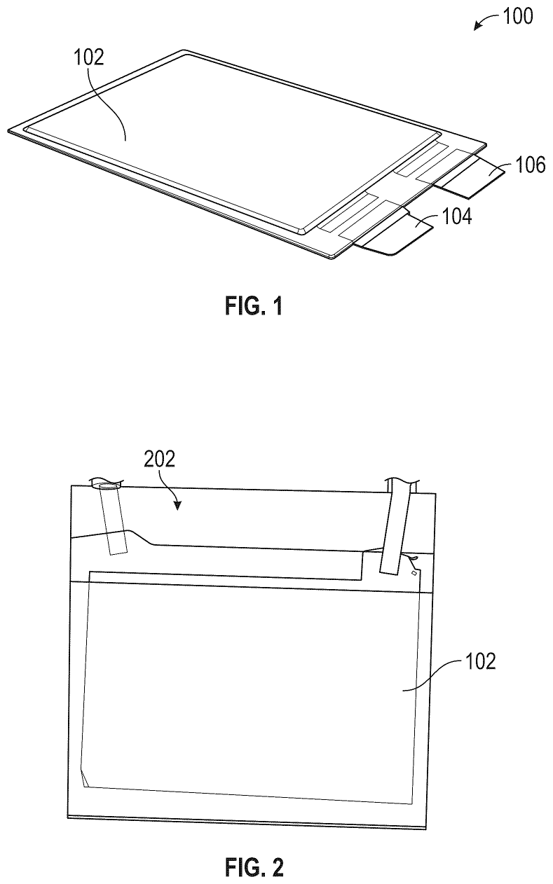

Referring now to FIG. 1, in one representative embodiment, a pouch-cell battery 100 may comprise a pouch body 102 with an anode tab 104 and a cathode tab 106 extending outwardly from one end of the pouch body 102. An internal structure (not shown) of the pouch-cell battery 100 may comprise a series of layered elements such as an anode, a cathode, a separator, and any other suitable layers for forming a battery. The internal structure of the pouch-cell battery 100 may present a visually non-distinct surface under inspection. For example, and referring now to FIG. 2, a digital radiograph (DR) 202 of the pouch body 102 of a pouch-cell battery 100 may reveal a uniformly grey image of the internal structure that is generally absent of any features.

To produce a more detailed image of the pouch-cell battery 100, it may be necessary to create an array of high-resolution sub-images of the pouch cell battery 100. These sub-images may then be stitched together to form a high-resolution composite image of the entire pouch-cell battery 100. Without any distinguishing features, however, it may be extremely difficult to register the sub-images such that they can be stitched together.

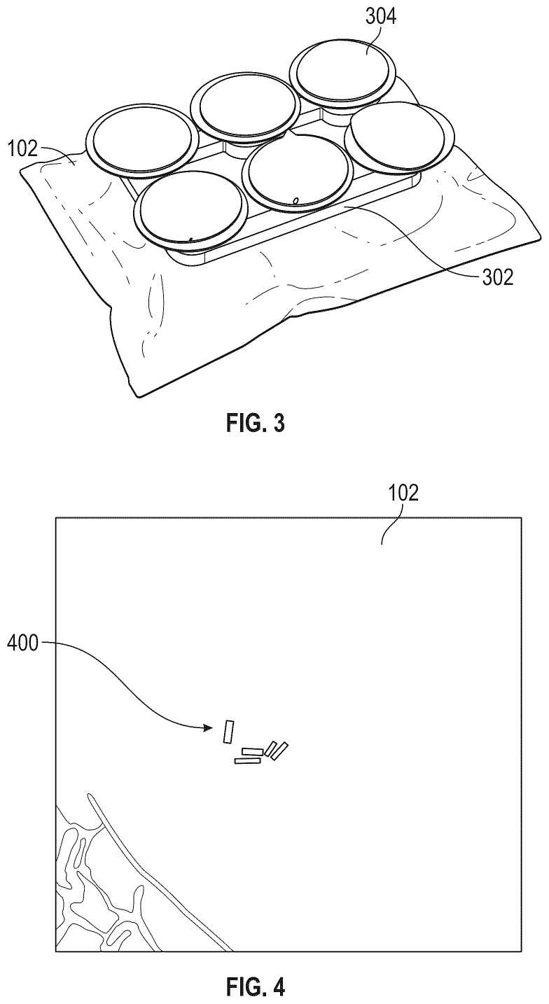

Referring now FIGS. 3 and 4, in one embodiment, an outward facing surface of the pouch body 102 may be modified to include a set of registration markers 400. The registration markers 400 may be affixed to the outward facing surface of the pouch body 102 by any suitable method. For example, a jig 302 having a set of locators 304 may be positioned over the pouch body 102. The locators 304 may be arranged in a grid pattern to allow the registration markers 400 to be positioned in distinct groups on the pouch body 102 at a predetermined spacing interval from each other. While the use of a jig 302 may ease the placement of the registration markers 400 and allow for a repeatable spacing pattern for the registration markers 400, one of skill in the art will recognize that a jig 302 isn't required in the placement of the registration markers 400.

The jig 302 may be configured to allow for an amount of an adhesive to be positioned within each locator 304 to fix the positions of the registration markers 400. Any suitable adhesive may be used to securely hold or affix the registration markers 400 in place on the outward facing surface of the pouch body 102. For example, in one embodiment, a small amount of a liquid photopolymer may be dropped into each locator 304 either prior to or after a desired number of registration markers 400 are positioned within each locator. The photopolymer may then be cured so that it hardens and adheres to the pouch body 102 fixing the registration markers 400 in place.

The adhesive used may be selected according to any desired criteria. For example, in one embodiment, the selected photopolymer may be invisible to a type of imaging system that is intended to be used to generate the sub-images. This allows the imaging system to see through the adhesive and into the internal structure of the pouch-cell battery 100 decreasing the potential that the adhesive will block any internal changes or other failure precursors from being imaged.

With continued reference to FIG. 4, the registration markers 400 may comprise any suitable material or device for creating a feature on the surface of the pouch body 102 to allow for the registration of the sub-images and subsequent formation of the composite image. In one embodiment, the registration markers 400 may be comprised of or formed from a material that produces a high signal return or increased contrast based on the modality of the imaging system being used to create the sub-images. For example, if a DR image is being taken of the pouch-cell battery 100, then the registration markers 400 may comprise a metal material such as small sections of copper wire or other magnet wire that produces a high signal return for the selected imaging system. Such materials produced image pixel values that were half the value (i.e., twice as attenuative) compared to other material pixel values, meaning the registration markers 400 were automatically and reliably identifiable by applicable registration algorithms. In another embodiment, where a thermal imaging system will be used, the registration markers 400 may be selected from a material that provides a high enough level of contrast such that the registration markers 400 are readily visible. In contrast, materials of registration marks from pouch-cell like materials would produce low signals because they are not attenuating to X-ray at the energy levels that are needed to interrogate the structure of a battery for defects.

Another embodiment of the present approach extends to a flexible pouch body 102 for a pouch-cell battery 100, where the flexible pouch body 102 is further adapted for use with a predetermined imaging device that may be used to obtain a series of high-resolution images. Such a flexible pouch may include a pouch body 102 configured to be positioned around electrode layers of the battery cell 100 (FIG. 3). With reference to FIG. 4, the pouch body 102 may also include a plurality of grouped registration markers 400, where each grouping of registration markers 400 is positioned along an outer facing surface of the pouch body 102. Each grouping of registration markers 400 may be arranged to form a distinct or unique pattern relative to the remaining groupings of the plurality of grouped registration markers 400. The material of registration markers 400 may be selected to provide a high signal return according to a type of imaging device used to obtain the series or set of high-resolution images.

The registration markers 400 may comprise a number of bodies arranged in a pattern at each registration marker 400 grouping. For example, a number of between three and eight small wire segments may be included within each registration marker 400 grouping. The arrangement of the registration markers 400 at each grouping location may comprise a different arrangement such that each grouping comprises a different or distinct pattern relative to the other groupings on the pouch body 102; in this way, a grouping, pattern, or arrangement may be a unique or distinct pattern relative to the remaining groupings of registration markers within a pouch, or within a desired or predetermined set or batch of pouches, for the purpose of identification of a pouch, battery, or other contents. The different patterns of registration markers 400 may thus increase the ability to identify each grouping thereby increasing the ability to register each sub-image.

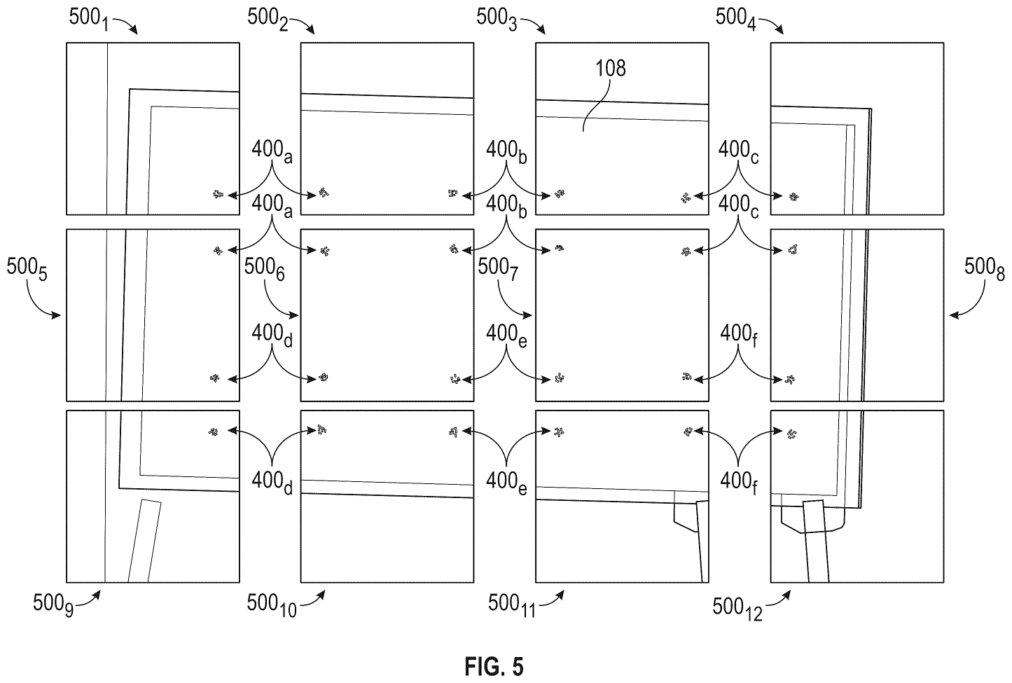

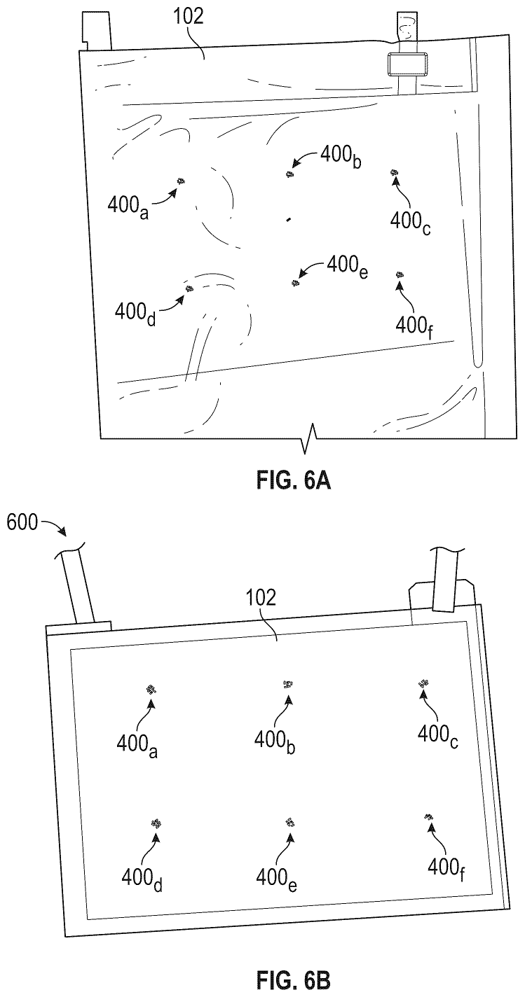

Referring now to FIGS. 5, 6A, and 6B, an array of high-resolution DR sub-images 500₁₋₁₂ may be taken of the pouch body 102 such that each sub-image 500 covers a portion of the pouch body 102 and includes at least one registration marker 400_{a-f}. More specifically and with particular reference to FIG. 6A, a set of 6 registration markers 400a, 400b, 400c, 400d, 400e, and 400f may be affixed to an outer facing surface of the pouch body 102 of the pouch-cell battery 100. The registration markers 400a-f may be positioned in a 2×3 array along the outer surface of the pouch body 102 such that there is a predetermined spacing between each grouping of registration markers 400a-f. Again, the groupings of registration markers 400 may be arranged in any suitable manner along the surface of the pouch body 102. The number of groupings and their arrangement along the pouch body 102 may be determined according to any suitable criteria such as the size and shape of the pouch body 102, a desired spacing between groupings of registration markers 400, a desired pixel scale of the sub-images 500, or the available image scale of the imaging system.

Referring again to FIG. 5, a series of 12 sub-images 500₁₋₁₂ of the entire pouch-cell battery 100 may be taken, wherein each sub-image 500 contains at least one group of registration markers 400a-f from the set of registration markers 400a-f. For example, a first sub-image 500₁ may be taken of an upper left-hand corner of the pouch-cell battery 100 wherein the first sub-image 500₁only includes one registration marker 400a. A second sub-image 500₂ immediately adjacent to the right of the first sub-image 500₁ may include two registration markers 400a and 400b. Continuing in this fashion across the entire surface of the pouch-cell battery 100, each sub-image 500 will contain a few as one and as many as four groups of registration markers 400.

After the individual sub-images 500₁₋₁₂ have been taken, they may be saved and loaded into a registration program where they are registered according to the identified locations of the registration markers 400a-f. The registered sub-images 500₁₋₁₂ may then be stitched together to form a single high-resolution composite image 600 (FIG. 6B). The stitching process utilizes the locations of the identified locations of the registration markers 400a-f to determine where each sub-image 500₁₋₁₂ should be positioned. For example, the stitching process can identify each sub-image 500₁₋₁₂ that includes registration marker 400e and knows that each of these registration markers 400e should be aligned with each other such that the individual elements making up the registration marker 400 itself should all be aligned with each other so that the individual sub-images 500 can be stacked over one another. The stitching process may repeat this analysis for each sub-image 500 until each is placed in the correct position and orientation to allow for the composite image 600 to be generated.

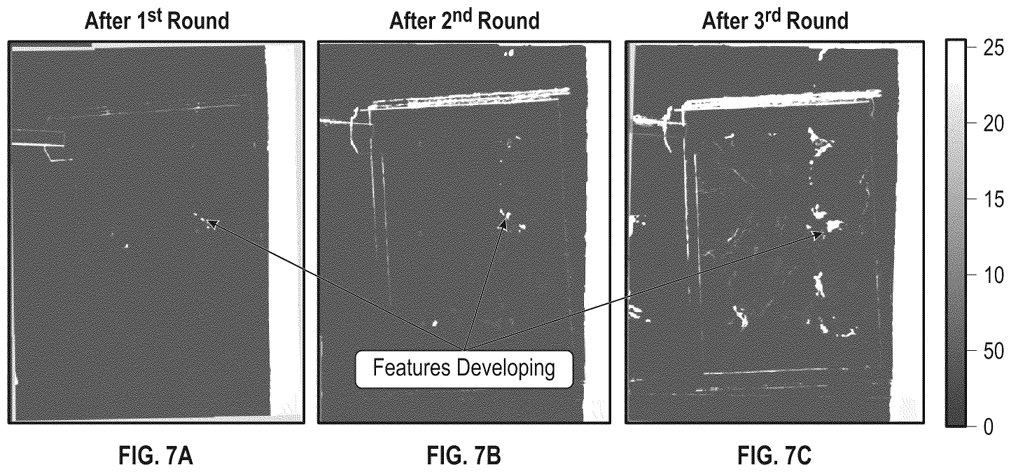

The first composite image 600₁ created may correspond to an initial state of the pouch-cell battery 100 prior to being placed into use or initial quality testing and may establish a baseline of the internal structure of the pouch-cell battery 100. During the operational life of the pouch-cell battery 100, new composite images 600₂, 600 ₃ may be taken and compared to the first composite image 600₁. For example, and referring now to FIGS. 7A, 7B, and 7C, the pouch-cell battery 100 may have a new composite image 600 created after a predetermined number of charge-discharge cycles have occurred. These subsequent composite images 600₂, 600₃ may then be compared to the first composite image 600₁ to determine if any changes to the internal structure of the pouch-cell battery 100 have taken place. Over time, the progression of defects or material changes may be monitored and tracked to obtain additional information on the reliability (e.g. expected life or mean time between failure) of the pouch-cell battery 100. This information may be used to set maintenance intervals or remove products from use prior to catastrophic failure.

These and other embodiments for creating high contrast markers on products with minimal features usable for registration may incorporate concepts, embodiments, and configurations as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A method for tracking internal changes of a lithium-ion pouch cell battery over time, comprising:
locating a plurality of registration markers along an outer facing surface of the lithium-ion pouch cell battery, wherein the registration markers are arranged in a distinct at least one grouping set apart from any neighboring grouping of registration markers;
obtaining an initial series of high-resolution images of the lithium-ion pouch cell battery, wherein each high-resolution image:
comprises a separate grid subsection making up the lithium-ion pouch cell battery; and
includes at least one grouping of registration markers;
registering each high-resolution image from the set of high-resolution images to identify a location for the at least one grouping of registration markers within the high-resolution image;
aligning the series of high-resolution images according to the identified at least one grouping of registration markers.

2. A method for tracking internal changes of a lithium-ion pouch cell battery over time according to claim 1, further comprising:
stitching the aligned series of high-resolution images together to generate a baseline single high-resolution composite image.

3. A method for tracking internal changes of a lithium-ion pouch cell battery over time according to claim 2, further comprising:
generating a second single high-resolution composite image based on a second series of high-resolution images of the lithium-ion pouch cell battery; and
comparing the second single high-resolution composite image to the baseline single high-resolution composite image to identify any internal changes to the lithium-ion pouch cell battery.

4. A method for tracking internal changes of a lithium-ion pouch cell battery over time according to claim 3, wherein:
the baseline single high-resolution composite image is created prior to initial usage of the lithium-ion pouch cell battery; and
the second single high-resolution composite image is created after a first period of usage involving a first number of charge-discharge cycles of the lithium-ion pouch cell battery.

5. A method for tracking internal changes of a lithium-ion pouch cell battery over time according to claim 4, further comprising:
generating a third single high-resolution composite image based on a third series of high-resolution images of the lithium-ion pouch cell battery, wherein the third single high-resolution composite image is created after a second period of usage involving a second number of charge-discharge cycles of the lithium-ion pouch cell battery occurring after the first period of usage; and
comparing the second and third single high-resolution composite images to the baseline single high-resolution composite image to identify any internal changes to the lithium-ion pouch cell battery.

6. A method for tracking internal changes of a lithium-ion pouch cell battery over time according to claim 3, wherein each high-resolution image used to form the composite image comprises a digital radiograph.

7. A method for tracking internal changes of a lithium-ion pouch cell battery over time according to claim 3, wherein the registration markers are selected to provide a high signal return according to a type of imaging device used to obtain the series of high-resolution images.

8. A method for tracking internal changes of a lithium-ion pouch cell battery over time according to claim 7, wherein the registration markers each comprise a small magnet wire.

9. A method for tracking internal changes of a lithium-ion pouch cell battery over time according to claim 3, wherein locating a plurality of registration markers along an outer facing surface of the lithium-ion pouch cell battery comprises:
identifying a position for each at least one grouping on the outer facing surface;
arranging one or more registration markers at each position; and
affixing the registration markers in place at each position to form the at least one grouping.

10. A method for tracking internal changes of a lithium-ion pouch cell battery over time according to claim 9, wherein affixing the registration markers in place comprises placing the registration markers in an amount of polymer liquid placed at each position and curing the polymer to fix each at least one grouping in place.

11. A method for tracking internal changes of a lithium-ion pouch cell battery over time according to claim 10, wherein polymer comprises a photopolymer invisible to an imaging system used to generate the high-resolution images.

12. A method of generating high-resolution images of a thin pliable material, comprising:
affixing a plurality of registration markers along an outer facing surface of the thin pliable material to form one or more distinct groupings of registration markers;
obtaining a series of high-resolution images of the thin pliable material, wherein each high-resolution image:
comprises a separate subsection of the thin pliable material; and
includes at least one of the one or more distinct groupings of registration markers;
registering each high-resolution image from the series of high-resolution images to identify a location for the one or more distinct groupings of registration markers within each high-resolution image;
aligning the series of high-resolution images according to the identified groupings of registration markers; and
stitching the aligned series of high-resolution images into a single high-resolution composite image.

13. A method of forming high-resolution images of thin pliable materials according to claim 12, wherein the registration markers are selected to provide a high signal return according to a type of imaging device used to obtain the series of high-resolution images.

14. A method of forming high-resolution images of thin pliable materials according to claim 12, wherein affixing a plurality of registration markers along an outer facing surface of the thin pliable material comprises:
identifying a position on the outer facing surface for each at least one grouping;
arranging one or more registration markers at each identified position; and
fixing the one or more registration markers in place at each position to form the at least one grouping.

15. A method of forming high-resolution images of thin pliable materials according to claim 14, wherein fixing the registration markers in position comprises placing the one or more registration markers in an amount of polymer liquid at each identified position and curing the polymer liquid to fix the one or more registration markers in place.

16. A flexible pouch for a battery cell, the flexible pouch further adapted for use with an imaging device used to obtain a series of high-resolution images, the flexible pouch comprising:
a pouch body configured to be positioned around electrode layers of the battery cell;
a plurality of grouped registration markers, wherein:
each grouping of registration markers is positioned along an outer facing surface of the pouch body;
each grouping of registration markers is arranged to form a unique pattern relative to the remaining groupings of the plurality of grouped registration markers; and
the registration markers are selected to provide a high signal return according to a type of imaging device used to obtain the series of high-resolution images.

17. A flexible pouch for a battery cell according to claim 16, wherein the plurality of grouped registration markers are arranged in a grid pattern along the outer facing surface of the pouch body.

18. A flexible pouch for a battery cell according to claim 16, wherein the registration markers are embedded within the pouch body.

19. A flexible pouch for a battery cell according to claim 16, wherein the registration markers are affixed to the outer surface of the pouch body with a polymer.

20. A flexible pouch for a battery cell according to claim 19, wherein:
the registration markers are selected to provide a high signal return according to a type of imaging device used to obtain a series of high-resolution images of the battery cell; and
the polymer is invisible to the imaging device.
